(19) United States
(12) Patent Application Publication
(10) Pub. No.: US 2006/0126095 A1
(43) Pub. Date: Jun. 15, 2006

(54) Image processing apparatus and image processing method

(75) Inventors: Yuji Tamura, Tokyo (JP); Tomohiro Suzuki, Tokyo (JP); Tetsuya Ishikawa, Tokyo (JP); Hiroyasu Nishimura, Tokyo (JP); Tomoya Ogawa, Tokyo (JP); Fumikage Uchida, Asaka-shi (JP); Nao Moromizato, Tokyo (JP); Masayuki Yasukaga, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/131,157

(22) Filed: May 16, 2005

(30) Foreign Application Priority Data
Dec. 9, 2004 (JP) JP2004-356117

(51) Int. Cl. G06K 15/00

(52) U.S. Cl. 358/1.14; 358/540

(57) ABSTRACT

There is described an image processing apparatus which can add an additional image, such as a water mark, to an image to be processed and output those images. The image processing apparatus includes: an image signals obtaining section which obtains image signals corresponding to an image; a judgment section which judges whether date and time information meets date and time for output when the image is outputted based on the image signals; and an output section which outputs the image without an image relating to date and time information when the judgment section judges the date and time information meets the date and time for output, and outputs the image with the image relating to date and time information based on the date and time information when the judgment section judges the date and time information does not meet the date and time for output.

This application is based on Japanese Patent Application NO. 2004-356117 filed Dec. 9, 2004 in Japanese Patent Office, the entire content of which is hereby incorporated by reference.

### BACKGROUND

1. Field of the Invention

The present invention relates to an image processing apparatus which can add an additional image, such as a water mark, to an image to be processed and output those images, and specifically relates to a technology that enables an additional image to be added only when the image is outputted during a certain period in which the additional image has to be added.

2. Description of the Related Art

Conventionally, in order to prevent confidential information printed on recording paper from leaking or being reproduced without permission, the “Confidential” or “No reproduction” mark is printed as an overlay print. Also, to prevent improper reproduction on the machine side, there is an image forming apparatus which detects whether a specific barcode is attached to a document to be reproduced, and prohibits the reproduction of the document when the barcode is attached to the document (for example, see Patent Document 1).

[Patent Document 1] Published Unexamined Japanese Patent Application No. Hei 8-65438

Some confidential information has a confidentiality expiration date. For example, a product catalog is confidential before the product is released, but, after the product has been on the market, it becomes public information. Therefore, it is necessary to print the “Confidential” mark on such printed matter before the confidentiality time expires. However, it is not necessary to add the “Confidential” mark after the confidentiality time has expired.

However, if print data is initially created with the “Confidential” mark attached, when the print data is used for printing after the confidentiality time has expired, the “Confidential” mark is still printed. Therefore, it is necessary to create another print data that does not have the “Confidential” mark, and also to judge which print data, with or without the mark, should be used when printing is to be done based on the expiration date of the confidentiality.

Furthermore, there is a problem in that when a document with the “Confidential” mark attached is reproduced by a copier after the confidentiality expiration date has passed, the reproduced document still has the unnecessary “Confidential” mark.

Besides the above, in some cases, a pamphlet for a newly released car has only descriptions and no photos of the car until the day the car is released, and once the car has been released, the pamphlet has both the descriptions and photos. Moreover, there is a need for printing a different text-image according to the period when the image is outputted. For example, in a movie hand bill, the text image of “Coming soon” may be printed at the beginning, “Coming (on a certain date)” may be printed when the date of release approaches, and “Now showing” may be printed after the movie has been released.

To respond to such demand, in the conventional technology, a plurality of print data each of which adds a different additional image, such as a “Confidential” mark, photo, or characters, to an original image, must be individually created, and properly used according to when the data is printed. This is a problem that involves a considerable amount of time and effort for the management.

### SUMMARY

In view of foregoing, an object of this invention is to provide new image processing apparatus. The apparatus comprises, an image signals obtaining section which obtains image signals corresponding to an image; a judgment section which judges whether date and time information meets date and time for output when the image is outputted based on the image signals, wherein the date and time information is used for judging whether the image is outputted with or without an additional image; and an output section which outputs the image without an image relating to date and time information when the judgment section judges the date and time information meets the date and time for output, and outputs the image with the image relating to date and time information based on the date and time information when the judgment section judges the date and time information does not meet the date and time for output.

In another aspect of the present invention, the apparatus comprises an image signals obtaining section which obtains image signals corresponding to an image; a judgment section which judges whether date and time information meets date and time for output when the image is outputted based on the image signals, wherein the date and time information is used for judging whether the image is outputted with or without an additional image; and an output section which outputs the image with an image relating to date and time information based on the date and time information when the judgment section judges the date and time information meets the date and time for output, and outputs the image without the image relating to date and time information when the judgment section judges the date and time information does not meet the date and time for output.

Further, to overcome the abovementioned problems,

### BRIEF DESCRIPTION OF THE DRAWINGS

Other objects and advantages of the present invention will become apparent upon reading the following detailed description and upon reference to the drawings in which:

FIG. 1 is a block diagram showing a configuration of an image processing apparatus according to an embodiment of the present invention;

FIG. 2(a), FIG. 2(b) and FIG. 2(c) are explanatory drawings showing an original image, a water mark (additional image) and its expiration date information mark, which are combined with the original image, and a document on which those images are combined, respectively;

FIG. 3 is an explanatory drawing showing a variety of information marks;

FIG. 4(a), FIG. 4(b), FIG. 4(c), FIG. 4(d) and FIG. 4(e) are explanatory drawings showing documents on which a plurality of information marks are combined and various output results which are reproductions of the documents;

FIG. 5 is a flow chart showing the operations by which an image processing apparatus according to an embodiment of the present invention reads a document and reproduces or displays the document;

FIG. 6(a), FIG. 6(b) and FIG. 6(c) are explanatory drawings showing an occasion in which an information mark is removed from the document on which the information mark has been included in a space created by shifting an original image, and then the original image is returned to the original position, and outputted;

FIG. 7(a), FIG. 7(b) and FIG. 7(c) are explanatory drawings showing an occasion in which an information mark is removed from the document on which the information mark has been included in a space created by reducing a size of an original image, and then, the original image is enlarged to the original size, and outputted;

FIG. 8(a), FIG. 8(b) and FIG. 8(c) are explanatory drawings showing an occasion in which an information mark is removed from the document on which the information mark has been included in a space created by reducing a size of an original image and shifting it, and then, the original image is enlarged to the original size and returned to the original position, and outputted;

FIG. 9(a), FIG. 9(b) and FIG. 9(c) are explanatory drawings indicating output examples in each of which a document, with a plurality of information marks combined, is reproduced;

FIG. 10 is an explanatory drawing indicating an example of a print data structure for which information about the inclusion of an additional image has been specified;

FIG. 11 is a flowchart indicating operations by which an image processing apparatus receives print data;

FIG. 12(a), FIG. 12(b) and FIG. 12(c) are explanatory drawings indicating examples in each of which an original image is shifted so as to combine an information mark;

FIG. 13(a), FIG. 13(b) and FIG. 13(c) are explanatory drawings indicating examples in each of which an original image is reduced so as to combine an information mark;

FIG. 14(a), FIG. 14(b) and FIG. 14(c) are explanatory drawings indicating examples in each of which an original image is shifted and reduced so as to combine an information mark;

FIG. 15 is an explanatory drawing indicating a part of print data that has date and time information that specifies both the addition start date and the addition end date for an additional image; and

FIG. 16 is an explanatory drawing indicating a correspondence of the printing date to the output result when print data of “Movie hand bill.doc” shown in FIG. 15 is printed.

In the following description, like parts are designated by like reference numbers throughout the several drawings.

### DETAILED DESCRIPTION OF THE PREFERRED EMBODIMENT

Hereafter, an embodiment of the present invention will be described with reference to the drawings.

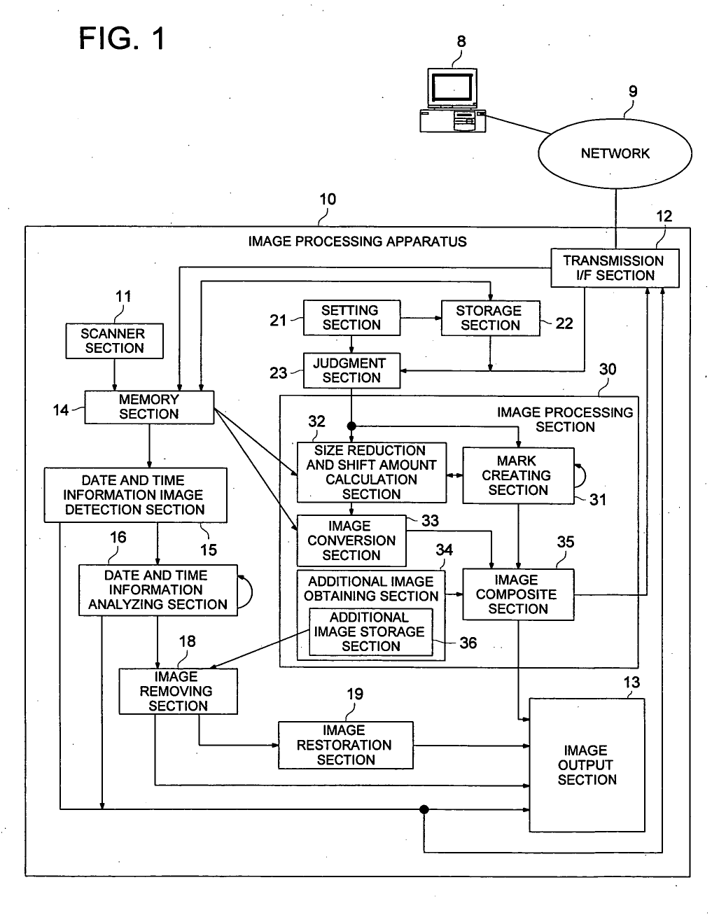

FIG. 1 shows the functional configuration of an image processing apparatus 10 according to an embodiment of the present invention. An image processing apparatus 10 is configured as a multi-function peripheral having a reproduction function for reading a document image and printing the reproduction and a printer function for printing according to the print data.

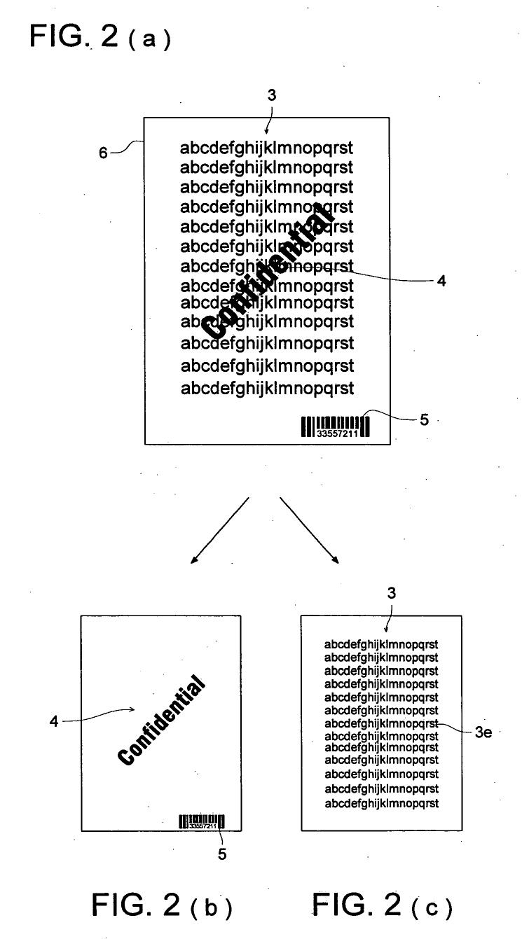

The image processing apparatus 10 has a judgment function for judging whether to add or not to add an additional image, such as a water mark, to an image to be processed (hereafter, also referred to as an original image) based on the date and time information specified for the document or print data when the read document is reproduced or printed according to the print data. For example, documents to be read by the image processing apparatus 10 include a document 6 on which an original image 3 of a confidential document has previously been combined with an additional image 4 of the “Confidential” character string and an information mark (date and time information image) 5 that indicates the expiration date (date and time information) in the form of a barcode, as shown in FIG. 2(a).

When the image processing apparatus 10 reads such a document 6, it analyzes the image of the information mark (date and time information image) 5 included on the page. And, it recognizes that an additional image 4 and an information mark (date and time information image) 5, shown in FIG. 2(b), have been combined with an original image 3 shown in FIG. 2(c) (that is, type and position of the additional image 4), as well as recognizing the expiration date by such time the additional image 4 is to be added. Then, if the current date and time is prior to the expiration date, the image processing apparatus 10 outputs a composite image that combines the original image 3 with the additional image 4 and the information mark (date and time information image) 5 as shown in FIG. 2(a). If the expiration date has passed, the image processing apparatus 10 removes the additional image 4 and the information mark (date and time information image) 5 from the read image, and outputs only the original image 3 as shown in FIG. 2(c).

Hereafter, an explanation will be given about the case in which date and time information is expiration date information which indicates the end of the period when an additional image is to be added, and the additional image is a water mark or an overlay image.

As shown in FIG. 1, an image processing apparatus 10, which is configured as stated above, comprises a scanner section 11 that is a reading section that obtaines image data by reading a document; a transmission and reception I/F section 12 that sends and receives various data to and from an external apparatus 8, such as a personal computer, via a network 9 including a LAN (local area network); and an image output section 13 that visualizes and outputs image data. The scanner section 11 and the transmission and reception I/F section 12 function as an image obtaining means. The image output section 13 comprises a display section, such as a liquid crystal display, and/or a printer section that forms an image on the recording paper.

Moreover, the scanner section 11 and/or the transmission and reception I/F section 12 functions as an original image obtaining section and a date and time information (expiration date information) obtaining section, the date and time information is used as the judgment reference for judging whether to add or not to add an additional image to the original image. Furthermore, the image output section 13 (display section and/or printing section) and/or the transmission and reception I/F section 12 function as an output section that outputs only an original image or a composite image which combines the original image with an additional image.

The image processing apparatus 10 further comprises a memory section 14, date and time information image detection section 15, date and time information analyzing section 16, image removing section 18, image restoration section 19, setting section 21, storage section 22, judgment section 23, and an image processing section 30. The memory section 14 temporarily stores image data obtained by reading a document by the scanner section 11 and print data received from an external apparatus 8 by the transmission and reception I/F section 12.

The date and time information image detection section 15 detects an information mark (date and time information image) by analyzing image data stored in the memory section 14. The date and time information analyzing section 16 analyzes the information mark (date and time information image) detected by the date and time information image detection section 15 and recognizes the content of the indicated information. When image data sent by an external apparatus 8 is received via a network 9, or when data stored in the image forming apparatus 10 is read out, the date and time information analyzing section 16 judges whether date and time information is accompanied by the image data, and when the analyzing section judges that it is accompanied, the analyzing section analyzes the date and time information and recognizes the content of the date and time information. The date and time information image detection section 15 along with the date and time information analyzing section 16 function as a judgment section that judges whether the image output date and time matches the date and time information based on the date and time information as well as judging whether to add or not to add an additional image. The image removing section 18 removes an additional image, such as a water mark, and an information mark (date and time information image) from image data. The image restoration section 19 restores the image that has been reduced or shifted in order to be combined with an information mark (date and time information image) by enlarging or shifting the image to restore it to its original condition. Moreover, the date and time information analyzing section 16 has a function for judging whether image output date and time matches the date and time information, and may also function as a judgment section 23. The image removing section 18 and/or the image restoration section 19 may also function as an image processing section 30.

The image processing section 30 comprises a mark creating section 31, size reduction and shift amount calculation section 32, image conversion section 33, additional image obtaining section 34 and an image composite section 35. The mark creating section 31 creates an information mark which indicates the type and provider of an additional image, the expiration date of the additional image, information of the area to which the additional image is added, and other information in the form of a barcode.

The image conversion section 33 functions as an additional area creation section that reduces or shifts an original image or an additional image in order to create space for combining an information mark. The size reduction and shift amount calculation section 32 functions as a overlap judgment section and a recognizing section that judge whether it is necessary to create space for combining an image and calculate the degree of size reduction and amount of shift that are to be transmitted to the image conversion section 33.

The additional image obtaining section 34 obtains additional image data. The additional image obtaining section 34 includes an additional image storage section 36 which stores image data relating to the prescribed additional image, such as a water mark, and obtains data about the prescribed additional image from the additional image storage section 36 unless otherwise specified. If the provider of the additional image is not the additional image storage section 36, but is specified separately, the additional image obtaining section 34 obtains an additional image from the provider. For example, the additional image obtaining section 34 includes a function to obtain additional images from a hard disk unit in the image processing apparatus 10 or from an external file server.

The image composite section 35 creates composite image data which combines an original image with an additional image and the information mark created by the mark creating section 31. Moreover, when an original image or an additional image has been reduced or shifted by the image conversion section 33, the image composite section 35 combines the converted image with the information mark.

Image data (image data only, or image data and additional image data, and/or date and time information) outputted by the image composite section 35, date and time information image detection section 15, image removing section 18, and the image restoration section 19 are inputted into the image output section 13, where the outputted image data is displayed and/or printed. Furthermore, image data outputted by the image composite section 35 and the date and time information image detection section 15 is also inputted into the transmission and reception I/F section 12 and can be transmitted to an external apparatus via a network 9.

The setting section 21 comprises a display section, such as a liquid crystal display (LCD), a touch panel located on the LCD screen, and other operation switches, and the setting section 21 forms a part of the operational display section of the image processing apparatus 10. By using the setting section 21, it is possible to make settings for adding a new additional image to an original image or for specifying the expiration date. That is, the setting section 21 comprises an additional image setting section and a date and time information setting section.

The storage section 22 stores image data of a document that has been read by the scanner section 11 or print data that has been received by the transmission and reception I/F section 12, and saves the specified data relating to the additional image set by the setting section 21 by relating it to the specified original image.

When print data received by the transmission and reception I/F section 12 or print data or image data stored in the storage section 22 are outputted, the judgment section 23 judges whether the image output date and time matches the expiration date information (date and time information) based on the expiration date information (date and time information) specified for the data, and then judges whether to add or not to add the additional image.

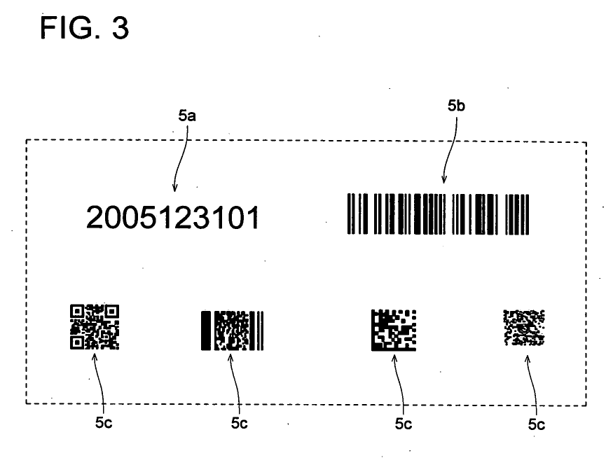

FIG. 3 shows a variety of examples of the information mark (date and time information image) 5. The information mark (date and time information image) 5a displays date and time information, such as expiration date, as characters or symbols. The information mark (date and time information image) 5b is a one-dimensional barcode, and the information mark (date and time information image) 5cs are a two-dimensional barcodes. FIG. 3 shows a plurality of two-dimensional barcodes that are different in standards.

Moreover, information marks (date and time information image) 5 includes the degree of size reduction and amount of shift of an original image and an additional image and the type of the additional image in addition to the expiration date. Furthermore, the reset code for canceling the information mark setter's name and the specified expiration date, additional image provider information (additional image storage location, server name, file name, etc.), and area information that indicates the composite position of the additional image can also be included. Furthermore, it is possible to encrypt such information as an expiration date by using a prescribed encryption key or an encryption key specified by a user and then convert the data into an information mark.

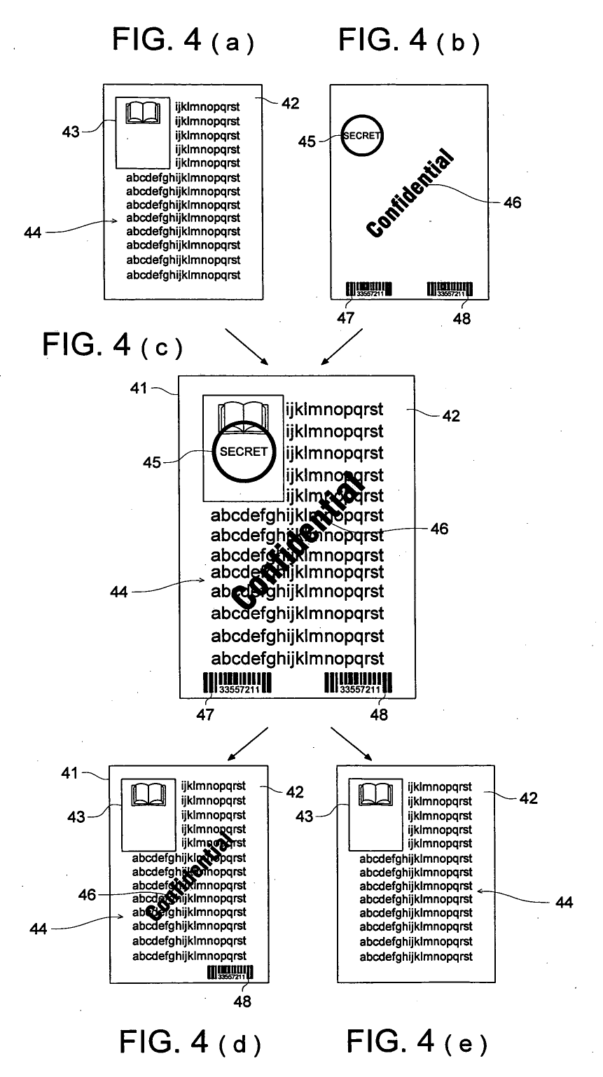

FIGS. 4(a) through 4(e) show examples of a document on which additional images and corresponding expiration dates are specified in a plurality of areas within the original image. A document 41 shown in FIG. 4(c) has combined an original image 42 shown in FIG. 4(a) with additional images 45 and 46 and information marks 47 and 48 shown in FIG. 4(b). As shown in FIG. 4(a), an image area 43 and a text area 44 are specified for the original image 42, and as shown in FIG. 4(b), the “SECRET” mark 45 having an expiration date is specified for the image area 43 as an additional image, and the “Confidential” mark 46 having a different expiration date is specified for the text area 44 as an additional image. The information mark 47 at the bottom left of the page is a barcode that shows the expiration date of the “SECRET” mark 45, and the information mark 48 at the bottom right of the page is a barcode that shows the expiration date of the “Confidential” mark 46.

When a plurality of information marks 47 and 48 are included in such a document 41 as shown in FIG. 4(c), the image processing apparatus 10 individually judges whether the image output date and time matches the specified expiration date information (date and time information) based on the expiration date information (date and time information) indicated by the information mark and determines whether to add or not to add an additional image corresponding to the information mark. For example, when the expiration date of the information mark 48 is later than the expiration date of the information mark 47, if the document 41 is reproduced prior to both expiration dates of the information marks 47 and 48, the output result has a composite image in which the original image 42 has been combined with the “SECRET” mark 45, “Confidential” mark 46, information mark 47 and the information mark 48, as shown in FIG. 4(c).

On the other hand, if the document 41 is reproduced after the expiration date of the information mark 47 has passed and before the expiration date of the information mark 48 passes (when the image output date and time matches the specified date and time information), the “SECRET” mark 45 and the information mark 47 are removed and the output result will have a composite image in which the original image 42 is combined with the “Confidential” mark 46 and the information mark 48 as shown in FIG. 4(d). If the document 41 is reproduced after both expiration dates of the information marks 47 and 48 have passed, the “SECRET” mark 45, “Confidential” mark 46 and the information marks 47 and 48 are removed from the document 41, and only the original image 42 will be outputted as shown in FIG. 4(e).

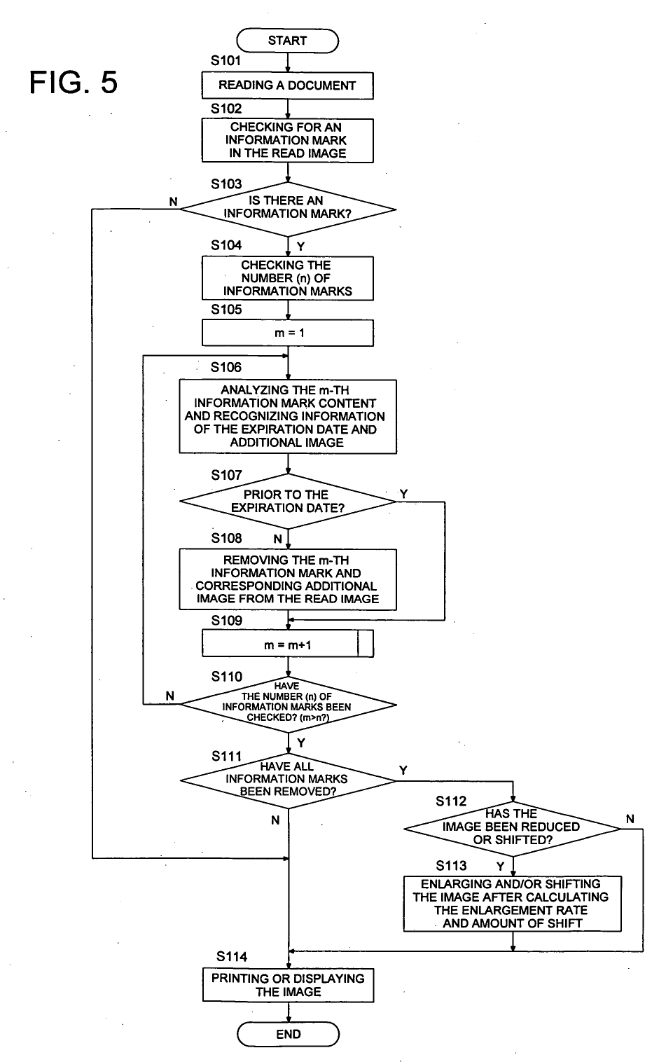

FIG. 5 shows the operations by which the image processing apparatus 10 reads a document and reproduces or displays it. FIG. 5 mainly shows the operations by which the image processing apparatus 10 adds or does not add an additional image. The image processing apparatus 10 reads a document placed by a user by means of a scanner section 11 (step S101), and detects an information mark located within the read image (step S102). The information mark is not always located in an expected position such as at the bottom margin of the page. Therefore, it is suggested that the checking for an information mark be conducted throughout the page. For example, if a document is invertedly placed on the scanner section 11 upside down, an information mark intended to be located at the bottom right of the document will be outputted at the upper left of the read image. Moreover, in such a case, it may be possible to inspect only the areas both at the bottom right and at the upper left, that is, only the area in which an information mark may be located.

If there is no information mark (step S103; N), the read image is printed or displayed (step S114) and the procedure will end (end).

When an information mark is detected (step S103; Y), the number (n) of detected information marks is checked (step S104). Next, variable m is initialized to “1” (step S105), and the content of the m-th information mark is analyzed, and then an expiration date indicated by the information mark, information relating to the additional image (information that specifies the type and position of the additional image), and other information (degree of size reduction and amount of shift, etc. are recognized (step S106).

The image processing apparatus 10 then judges whether the current date and time is prior to the expiration date that has been recognized from the m-th information mark (judgment of whether the current date and time matches the specified date and time information), and if the current date and time is not prior to the expiration date (no matching) (step S107; N), the image processing apparatus 10 removes the m-th information mark and the corresponding additional image from the read image (step S108).

After that, or when the current date and time is prior to the expiration date that has been recognized from the m-th information mark (matching the specified date and time information) (step S107; Y), the image processing apparatus 10 does not perform the above-mentioned removal procedure, but adds “1” to variable m (step S109). If the value of variable m is equivalent to or less than the number (n) of detected information marks (step S110; N), the procedure will return to step S106, and the same procedures will be executed for the subsequent information mark (steps S106 to S109).

If the value of variable m exceeds the number (n) of detected information marks, and all of the above procedures (steps S106 to S109) have been completed for all of the information marks (step S110; Y), the image processing apparatus 10 judges whether all of the information marks have been removed from the read image (step S111). When all of the information marks have been removed (step S111; Y), the image processing apparatus 10 judges whether an original image or an additional image in the read image has been reduced and/or shifted in order to create a composite area into which an information mark is included based on the information mark analysis result that has previously been recognized (step S112). If the original image or additional image has been reduced and/or shifted (step S112; Y), that image is enlarged and/or shifted, and then restored to its original size at the original location (step S113). The restored image will be printed or displayed (step S114) and the procedure will end (end).

If the original image or additional image has not been reduced or shifted (step S112; N), or if any one of the information marks still remains (step S111; N), the above restoration procedure is not executed, and the image is printed or displayed (step S114) and the procedure will end (end).

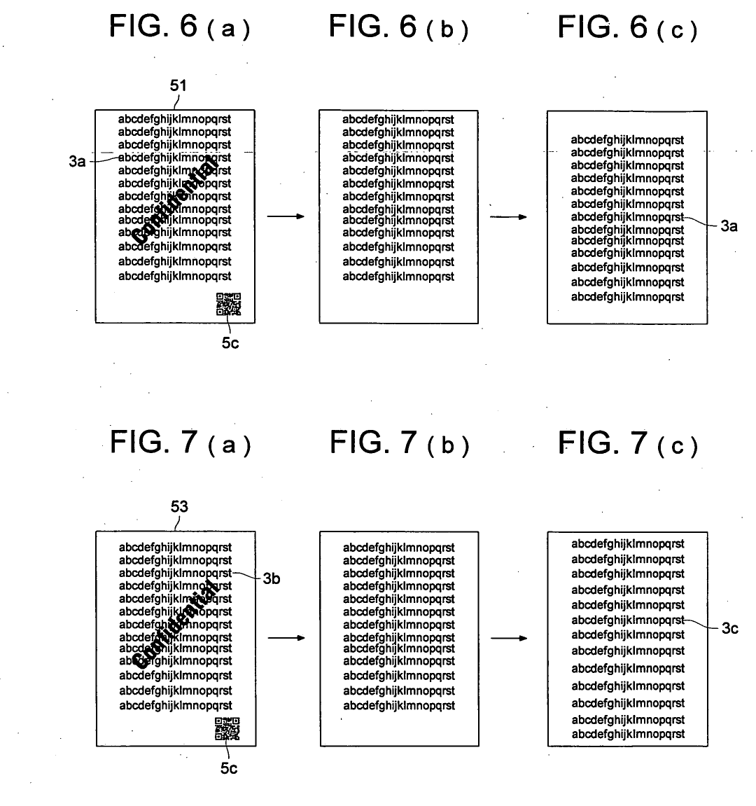

FIGS. 6(a) through 6(c) show examples in each of which an original image has been shifted in order to include an information mark. As shown in FIG. 6(a), on the document 51, the top margin has been reduced and the original image 3a has been shifted up in order to create a composite space to include an information mark (date and time information image) 5c. When all of the information marks (date and time information image) 5c have been removed from such a document 51 (FIG. 6(b)), the original image 3a is shifted down and printed in the original position (FIG. 6(c)).

FIGS. 7(a) through 7(c) show examples in each of which an original image has been reduced in order to combine an information mark. As shown in FIG. 7(a), on the document 53, the original image 3b has been reduced in order to create a composite space to combine an information mark (date and time information image) 5c. When all of the information marks (date and time information image) 5c have been removed from such a document 53 (FIG. 7(b)), the original image 3b is enlarged to the size equivalent to the original image 3c and printed (FIG. 7(c)).

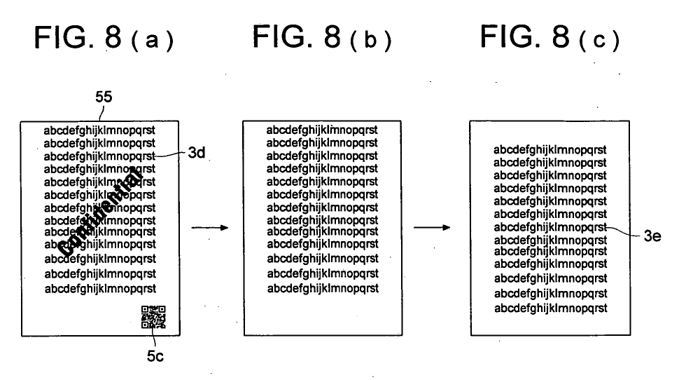

FIGS. 8(a) through 8(c) show examples in each of which an original image has been reduced and shifted in order to combine an information mark. As shown in FIG. 8(a), on the document 55, the original image 3d has been reduced and shifted up to reduce the top margin in order to create a composite space to combine an information mark (date and time information image) 5c. When all of the information marks (date and time information image) 5c have been removed from such a document 55 (FIG. 8(b)), the original image 3d is enlarged to the size equivalent to the original image 3e and also shifted down, and printed in the original position (FIG. 8(c)).

Moreover, it is possible to judge whether the above-mentioned original image has been reduced and outputted and/or whether the original image has been shifted and outputted by comparing the sizes of the top margin and the bottom margin, or by using information about the sizes of the left and right margins in addition to the top and bottom margins, or by recognizing the ratio of the size of the original image in relation to the entire output area. Furthermore, instead of depending on the above judgments, it is possible to include information about the amount of shift (output position information) and/or information about the degree of size reduction beforehand in the information mark, and control the image output based on the information about the amount of shift and/or degree of size reduction when an information mark (date and time information image) is not outputted.

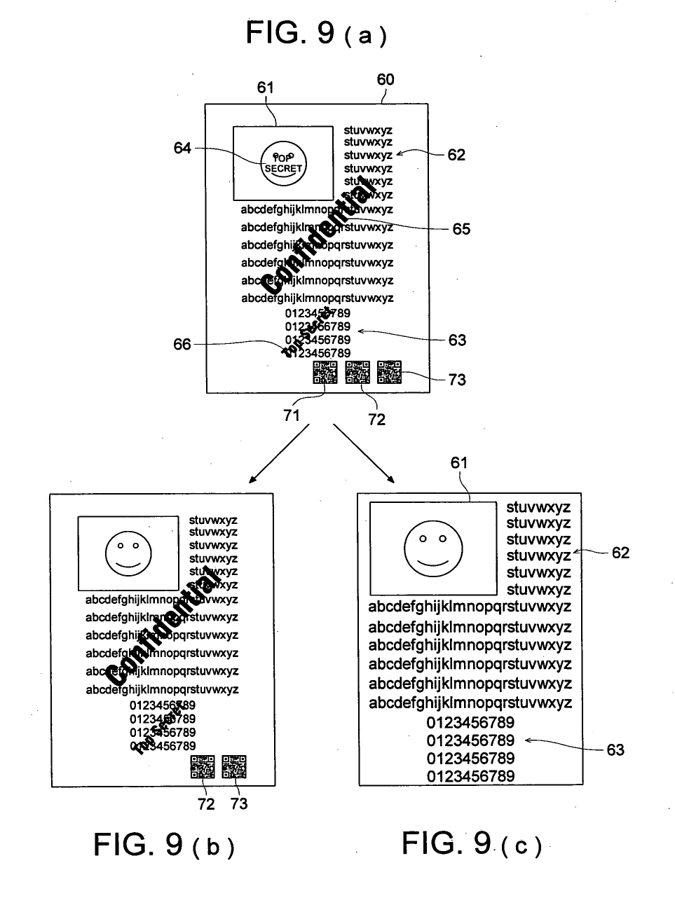

FIGS. 9(a) through 9(c) show output examples in each of which a document with a plurality of information marks combined is reproduced. Three areas have been specified on document 60 shown in FIG. 9(a): a photo area 61 to which a photo has been affixed, first text area 62, and a second text area 63. The “TOP SECRET” mark 64 has been added to the photo area 61 as an additional image, and the “Confidential” mark 65 has been added to the first text area 62, and the “Top Secret” mark 66 has been added to the second text area 63. At the bottom of the page, a first information mark 71 corresponding to the photo area 61, a second information mark 72 corresponding to the first text area 62, and a third information mark 73 corresponding to the second text area 63 have been combined. In this example, the expiration date indicated by the first information mark 71 is earlier than the expiration dates shown by the second information mark 72 and the third information mark 73, and original images 61, 62 and 63 have been reduced to combine information marks 71 through 73.

FIG. 9(b) shows the output result when the document 60 is reproduced after the expiration date indicated by the first information mark 71 has passed but before the expiration dates indicated by the second information mark 72 and the third information mark 73 pass. The “TOP SECRET” mark 64 and the first information mark 71 are removed, but the “Confidential” mark 65, “Top Secret” mark 66, second information mark 72, and the third information mark 73 remain as additional images and are outputted.

FIG. 9(c) shows the output result when the document 60 is reproduced after the expiration dates indicated by all of the information marks 71 through 73 have passed. In this case, all of the information marks 71 through 73 are removed, and original images 61, 62 and 63 are enlarged and restored to their original sizes. Moreover, examples are shown above which prevent a composite image that combines an original image and an additional image from interfering or overlapping with a date and time information image. However, the example can be applied in order to prevent an image that has no additional image from interfering or overlapping with a date and time information image.

Instead of applying the above embodiment, it is possible to externally obtain image data from an external apparatus 8. Furthermore, it is also possible to specify an additional image by an external apparatus 8. That is, an additional image setting section can be disposed in an external apparatus 8 instead of disposing it in an image forming apparatus 10 which is an image processing apparatus. Furthermore, it is possible to specify date and time information by an external apparatus 8. That is, a date and time information setting section can be disposed in an external apparatus 8 instead of disposing it in an image forming apparatus 10 which is an image processing apparatus.

Next, the operations by which print data that includes information about the inclusion of an additional image is received will be described.

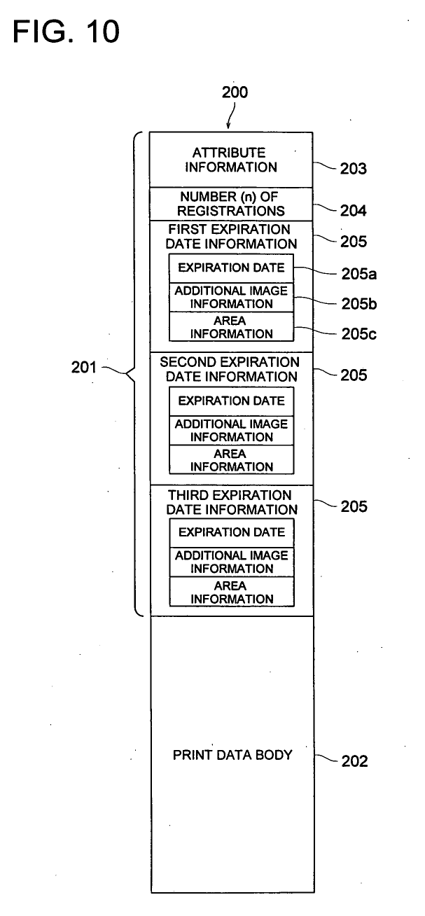

FIG. 10 shows an example of a print data structure for which information about the inclusion of an additional image has been specified. Print data 200 includes a header section 201 and a print data body 202. Attribute information 203 that indicates a file name, recording paper size, and the like, the number of registrations 204, and expiration date information 205 have been registered in the header section 201. In this example, first through third expiration date information 205 has been registered.

The number of registrations 204 indicates the number of expiration date information 205. The expiration date information 205 includes expiration date 205a, additional image information 205b, and area information 205c. Additional image information 205b indicates the type of an additional image. Additional image data or additional image provider information can be registered as additional image information 205. For example, it is possible to register file name and the provider's server name as additional image provider information. Information that specifies the position where an additional image is to be added within the original image is registered as area information 205c. Specifically, the position and size of the area into which an additional image is added is registered.

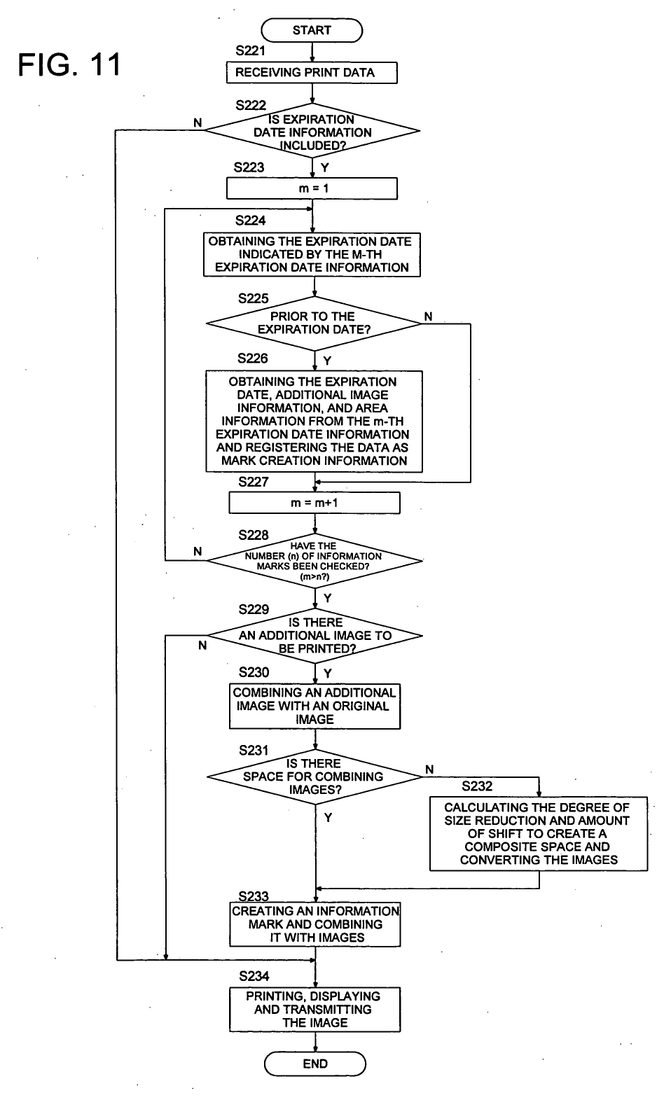

FIG. 11 shows the operations by which an image processing apparatus 10 receives print data. When an image processing apparatus 10 receives print data from an external apparatus 8 or the like (step S221), it judges whether expiration date information 205 has been set for the print data (step S222).

If expiration date information 205 is not specified (step S222; N), the image processing apparatus 10 prints, displays or transmits an image shown by the print data body 202 (step S234), and the procedure will end (end).

When expiration date information 205 has been specified (step S222; Y), the image processing apparatus 10 recognizes the number of registrations (n), initializes variable m to “1” (step S223), and obtains the expiration date indicated by the m-th expiration date information 205 (step S224). The image processing apparatus 10 will then judge whether the current date and time is prior to the expiration date indicated by the m-th expiration date information 205 (judgment of matching the specified date and time information), and if the current date and time is prior to the expiration date (step S225; Y), the image processing apparatus 10 registers the content of the m-th expiration date information 205 in the memory, not shown, as mark creation information (step S226). The mark creation information will become basic data for the mark creating section to create information marks.

After that, or when the current date and time is not prior to the expiration date indicated by the m-th expiration date information 205 (step S225; N), the above registration procedure is not executed (S226), and “1” is added to the value of variable m (step S227). When the value of variable m has not exceeded the number of registrations (n) of the expiration date information 205 (step S228; N), the procedure will return to step S224, and the same procedures will be executed for the subsequent expiration date information 205 (steps S224 to S227).

When the value of variable m has exceeded the number of registrations (n) of the expiration date information 205 and all of the above procedures (steps S224 to S227) have been completed for all of the expiration date information 205 (step S228; Y), the image processing apparatus 10 judges whether there is an additional image to be printed (step S229). That is, the image processing apparatus 10 determines that there is an additional image to be printed when at least one piece of mark creation information has been registered, and it determines that there is no additional image to be printed when no mark creation information has been registered. Moreover, mark creation information is cleared at the point of time print data is received (beginning of the procedure).

When there is no additional image to be printed (step S229; N), the image processing apparatus 10 prints, displays or transmits the image indicated by the received print data body 202 (step S234) and the procedure will end (end).

When there is an additional image to be printed (step S229; Y), the image processing apparatus 10 combines the corresponding additional image with an original image indicated by the print data body 202 (step S230). If the additional image information 205b indicates a certain type of prescribed additional image, such as a water mark, the image processing apparatus 10 obtains corresponding additional image data from the additional image storage section 36 of the additional image obtaining section 34 and combines the image. If the additional image information 205b is additional image provider information, the image processing apparatus 10 obtains an additional image from the provider and combines the image.

After having created a composite image that includes an additional image, the image processing apparatus 10 judges whether there is space for combining the image with an information mark (date and time information image) 5 (step S231), and if there is no space (step. S231; N), the image processing apparatus 10 reduces and/or shifts the composite image that has been created in step S230 by including an additional image to create space for the composite (step S232).

In the space created as mentioned above or in the space that has been originally created (step S231; Y), the image processing apparatus 10 creates and combines necessary information marks (step S233). The image processing apparatus 10 will then print, display, or transmit the composite image (step S234) and the procedure will end (end). The mark creating section 31 creates information marks based on the mark creation information.

In this embodiment, a transmission and reception I/F section 12 that externally receives print data is described as an image data obtaining section. However, the present invention is not intended to be limited to such section, and it may be an apparatus having a function that can read image data which has been created by an application, such as a word processor, and stored in the image processing apparatus 10 or stored in an external apparatus.

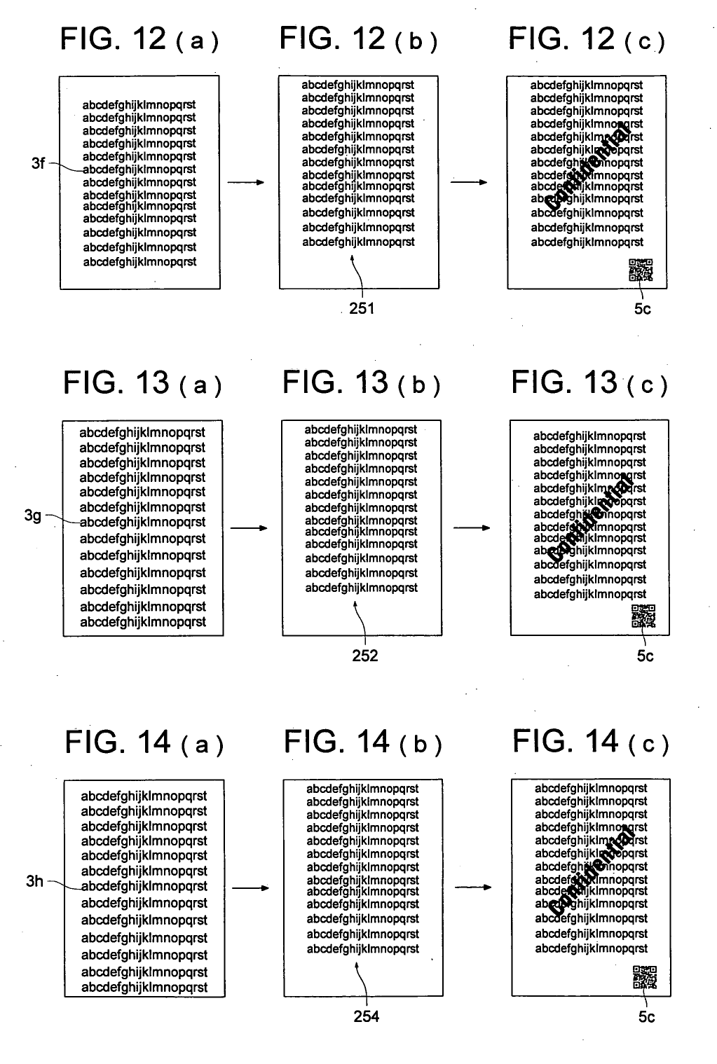

FIGS. 12(a) through 12(c) show examples in each of which an original image is shifted so as to combine an information mark. As shown in FIG. 12(a), because there is a margin above the original image 3f, the original image 3f has been shifted up to ensure a necessary amount of space 251 at the bottom (FIG. 12(b)), and an information mark (date and time information image) 5c is combined therein (FIG. 12(c)).

FIGS. 13(a) through 13(c) show examples in each of which an original image is reduced so as to combine an information mark. As shown in FIG. 13(a), because there are almost no margins both above and below the original image 3g, it is not possible to create space for combining images. Therefore, in such a case, the original image 3g is reduced to create space 252 (FIG. 13(b)) in which an information mark (date and time information image) 5c is combined (FIG. 13(c)). Moreover, in an example shown in FIG. 13, because an information mark (date and time information image) 5c is included at the bottom of the page, the original image 3g is reduced leaving the center of the top end as a reference position, thereby creating an appropriate bottom margin.

FIGS. 14(a) through 14(c) show examples in each of which an original image is reduced and shifted so as to combine an information mark. As shown in FIG. 14(a), because the top margin 253 is narrow, it is not possible to ensure space for combining an information mark (date and time information image) 5c by simply shifting up the original image 3h. Therefore, a space 254 has been created by shifting and reducing the original image (FIG. 14(b)), and an information mark (date and time information image) 5c is combined therein (FIG. 14(c)). In this example, the shifting operation takes priority over the size reduction operation, thereby preventing an original image from deteriorating.

As the above examples clearly explain, this embodiment prevents a composite image that combines an original image with an additional image from interfering or overlapping with a date and time information image when those images are outputted. And, this embodiment controls the position in which a composite image that combines an original image and an additional image is outputted according to the judgment result made by the overlap judgment section. As a more specific example, this embodiment controls the composite image output position by comparing the date and time information image recordable area with the size of the date and time information image.

Furthermore, it is also possible to control the size (size reduction) of the outputted composite image that combines an original image and an additional image according to the judgment result made by the overlap judgment section. As a more specific example, the size of the composite image to be outputted is controlled by recognizing the size of the date and time information image and then creating an area in which date and time information can be recorded.

Furthermore, there are another possible embodiments in which information about the degree of size reduction and/or the amount of shift (output position information) is externally received together with date and time information by using a transmission and reception I/F section 12, or the information is obtained by reading an information mark provided on the document, or the information is obtained by an IC tag attached to the document.

Moreover, information marks can include the above-mentioned degree of size reduction and shift amount in addition to the expiration date. Furthermore, the information marks can also include the name of the person who has set the inclusion of an additional image and its expiration date, reset code for resetting the specified expiration date, additional image provider information (storage location, server name, file name of the additional image), and position information that indicates the additional image composite position. Moreover, it is possible to encrypt information such as an expiration date by using a prescribed encryption key or an encryption key specified by a user and then convert the information into an information mark.

Next, the situation will be explained in which both the image addition start date (period start date) and the image addition end date (period end date) can be specified as date and time information.

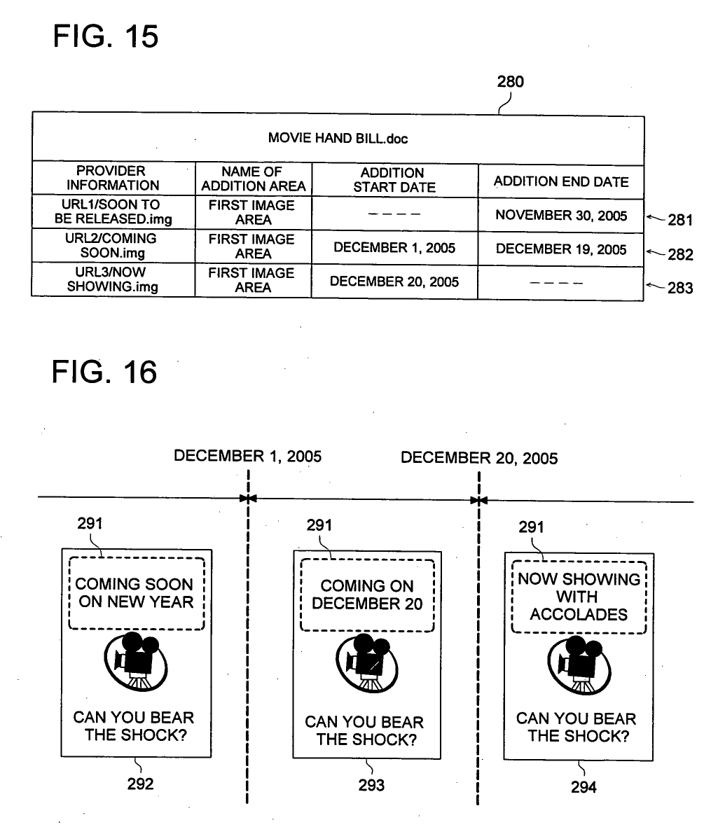

FIG. 15 shows a part of the header information 280 of print data that has date and time information that specifies both the addition start date and the addition end date for an additional image. The header information 280 is included in the print data that has a file name of “Movie hand bill.doc.” In the header information 280, additional image provider information, name of the additional image inclusion area, addition start date, and the addition end date, which are arranged in a horizontal row in the drawing, configure settings relating to one “addition” operation. If the addition start date or addition end date is vacant (“- - - -” is shown in the drawing), the date has not been specified. Moreover, in examples shown in FIGS. 4(a)-4(e) and FIG. 9, date and time information (expiration date information: information mark) is specified for each area; however, in an example shown in FIG. 15, date and time information is specified for each additional image.

With regard to set data 281 for an additional image having provider information of “URL1/Soon to be released.img”, the additional area is the first image area, the addition start date is not specified, and the addition end date is Nov. 30, 2005. With regard to set data 282 for an additional image having provider information of “URL2/Coming soon.img”, the additional area is the first image area, the addition start date is Dec. 1, 2005, and the addition end date is Dec. 19, 2005. Furthermore, with regard to set data 283 for an additional image having provider information of “URL3/Now showing.img”, the additional area is the first image area, the addition start date is Dec. 20, 2005, and the addition end date is not specified. If print data having such settings is stored in an external apparatus 8 or the like, and transmitted to an image processing apparatus 10 and printed when necessary, it is possible to automatically change an additional image that is included in the first image area according to the date on which data is printed.

FIG. 16 shows the correspondence of the printing date to the output result when print data of “Movie hand bill.doc” shown in FIG. 15 is printed. If the data is printed by Nov. 30, 2005, a character string of “Coming soon on New Year” is included in the first image area 291 and a “Coming soon” hand bill 292 is outputted.

If the data is printed between Dec. 1 and Dec. 19, 2005, another “Coming soon” hand bill 293 is outputted which has a character string of “Coming on December 20” in the first image area 291. If the data is printed after Dec. 20, 2005, a “Now showing” hand bill 294 is outputted which has a character string of “Now showing with accolades” in the first image area 291.

Thus, by diversifying settings of whether to add or not to add an additional image to a single original image by using date and time information, it is possible to automatically change the additional image to be added according to the specified date and time information, thereby reducing troublesome procedures to manage printing contents according to the output date and time. Moreover, FIG. 16 shows an output example in which a setting has been made so that the information mark is not combined and printed.

When combining an information mark, it is possible to indicate provider information, area information about the name and position of the additional image inclusion area, and date and time information that indicates an addition start date and addition end date as images, such as two-dimensional barcodes, and then add the created provider information image, area information image, and the date and time information image. In this case, it is suggested not adding information marks relating to additional images which have an addition end date that has passed when the data is outputted. For example, when the “Movie hand bill.doc” print data, set as shown in FIG. 15, is outputted on Dec. 10, 2005, it is recommended that information marks corresponding to preset data 281 should not be added, and only information marks corresponding to preset data 282 and preset data 283 be added.

Thus, embodiments of the present invention have been explained with reference to the drawings. However, specific configurations are not intended to be limited to the embodiments, and can be embodied in a variety of forms with changes and additions as long as they do not depart from the concept of the present invention.

For example, in the embodiments, a read image scanned by a scanner section 11 is reproduced; however, another configuration is possible in which the read image is stored in the storage section 22 and will be later retrieved and printed. In this case, it is recommended that the presence or absence of an information mark and its content be analyzed from the image when data is outputted and it is judged whether the additional image is to be added or not to be added (removed or not removed) according to the recognized date and time information about the expiration date.

Furthermore, in the embodiments, the size reduction and shift amount calculation section 32 obtains the degree of size reduction and the amount of shift when an information mark is combined; however, it is possible to reduce or shift an image according to the degree of size reduction and the amount of shift if the data has been specified in the print data's header information.

Moreover, in the embodiments, an information mark is combined for each area or each additional image; however, if specified contents of a plurality of areas or a plurality of additional images are successfully included in one information mark in terms of the amount of information, the contents can be included in one information mark.

Furthermore, it is also recommended that whether to add or not to add an information mark to an original image can be selected. For example, the configuration assumes the situation in which print data that has settings of the inclusion of an additional image is stored and a judgment of whether to add or not to add the additional image is executed only when the print data is printed. In this case, it is not necessary to provide expiration date information (date and time information) for the printout result, and therefore, it is recommended not to combine information mark with an original image. Since an unnecessary information mark is not added, artistically pleasing printed matter can be obtained.

In the embodiments, date and time information is expressed as the date; however, it is possible to include time, minute, and second. Furthermore, if an IC tag has been embedded in the recording paper, it is possible to write information indicated by an information mark in the IC tag. Moreover, when content of information is not comprehensive because it is indicated as a one-dimensional or two-dimensional barcode, it is recommended that an expiration date and other contents be additionally displayed by using comprehensive characters and/or symbols.

Additional images are not intended to be limited to those shown in the embodiments, and any image can be used. For example, if an image is somewhat restricted by a copyright, it is recommended that date and time information which indicates whether to add or not to add the additional image be set according to the restriction.

Furthermore, in the embodiments, information marks are combined in the bottom margin of the page; however, those marks can be included in any other locations. It is preferable that those marks be located at any corner: upper, lower, right or left.

Moreover, by using a two-dimensional barcode as an information mark, it is possible to detect an inclination of the document that has been read by the scanner section 11. Based on the detected inclination, it is possible to accurately recognize the position (inclination) of the water mark, thereby properly removing the water mark.

In the first and second embodiments, date and time information is used to set the expiration date for adding an additional image and/or a date and time information image, and when the image output date and time matches the date and time information, the additional image and/or the date and time information image are added, and when the image output date and time does not match the date and time information, the additional image and/or the date and time information image are deleted. However, other than this example, the following configurations are also applicable: when the image output date and time matches the date and time information which specifies the image output date and time, an additional image and/or a date and time information image are removed and only an original image is outputted; and when the image output date and time does not match the date and time information, an additional image and/or a date and time information image are added and the composite image is outputted.

In short, it is sufficient to judge whether to add or remove an additional image and/or a date and time information image based on the date and time information and execute the procedures when the image is outputted according to the image data.

Moreover, in the present invention, “output” means an action that results in visual representation of data in a printed or displayed form. An image output section has a display section, such as a liquid crystal display, and/or a printer section for forming images on the recording paper. Furthermore, the image output section may also have a data transmission section for transmitting data to an external display section and/or a printer section on the premise that the data is to be outputted in a visible form by the external display section and/or the printer section.

According to the present invention, at least one the following effects can be attained.

1). An image processing apparatus according to at least one aspect of the present invention judges whether to add or not to add an additional image, such as a water mark, to an image to be processed based on date and time information that has been specified for the image to be processed, thereby making it possible to automatically add or not add an additional image to the image to be processed according to the output date and time or the reproduction date and time. By doing so, troublesome management procedures are eliminated in which two kinds of documents or print data, with or without an additional image added to the image to be processed, are created and used appropriately according to when the data is outputted or reproduced, thereby improving convenience of operations.

2). Especially when date and time information is expiration date information that indicates the end of the period in which an additional image is to be added, this apparatus is suitable for an occasion in which the “Confidential” mark is added as an additional image to the document having a confidentiality expiration date. That is, after the confidentiality time has expired, the “Confidential” mark is not automatically added. As a result, it is easy to produce the proper output result according to whether the confidentiality time has expired.

3). In cases when date and time information indicates the date and time at which an additional image begins to be added or the date and time at which an additional image ceases to be added, or indicates both dates and time, it is possible to add an additional image before a certain date and time passes and not add it after the certain date has passed, or not to add an additional image before a certain date and time passes and add it after the certain date has passed, or to combine both situations. Thus, it is possible to add or not to add an additional image in many ways according to the sequence of the output date and time.

4). When an obtaining section obtains image provider information, and additional images are provided by the provider indicated by the provider information, additional images are not limited to those images that have been stored in an output apparatus or those images that are directly provided by a provider of an image to be processed. Accordingly, it is possible to obtain additional images, for example, from the server in a network and add such images to the image to be processed.

5). In cases when an additional image is combined with an image to be processed together with a date and time information image and outputted as a composite image, even if the output result is reproduced later, it is possible to create reproduced matter by judging whether to add or not to add an additional image based on the date and time information image included in the output result.

6). In cases when an image to be processed or an additional image is reduced or moved because there is no space for combining a date and time information image and a provider information image, it is possible to eliminate the overlapping of the images, thereby preventing the date and time information image and the provider information image from being mistakenly recognized when the images are analyzed. Deterioration of the image to be processed can also be reduced.

7). When an additional image and a date and time information image have previously been combined with the obtained image to be processed, and that composite image is outputted or reproduced during the time when the additional image does not need to be added, and the combined additional image and date and time information image are to be removed from the obtained image in order to output only the obtained image, it is possible to reproduce the image to be processed as good a quality as the original image which has not yet been combined with the additional image and the date and time information image. As a result, a high-quality output result can be obtained.

8). Furthermore, in cases when an image to be processed is enlarged to the original size or returned to the original position after the date and time information image has been removed, it is possible to reproduce the image to be processed which has the improved quality.

9). In cases when it is judged whether to add or not to add an additional image for each area or each additional image according to date and time information that has been specified for each of the areas provided in an image to be processed or for each additional image, it is possible to flexibly change output content according to a difference in output date and time or reproduction date and time. Consequently, it is possible to respond to a variety of output requests.

It is to be noted that various changes and modification will be apparent to those skilled in the art. Therefore, unless such changes and modifications depart from the scope of the present invention, they should be construed as being included therein.

What is claimed is:

1. An image processing apparatus, comprising:
an image signals obtaining section which obtains image signals corresponding to an image;
a judgment section which judges whether date and time information meets date and time for output when the image is outputted based on the image signals, wherein the date and time information is used for judging whether the image is outputted with or without an additional image; and
an output section which outputs the image without an image relating to date and time information when the judgment section judges the date and time information meets the date and time for output, and outputs the image with the image relating to date and time information based on the date and time information when the judgment section judges the date and time information does not meet the date and time for output.

2. The image processing apparatus of claim 1,
wherein the output section outputs the image relating to date and time information so as not to interfere with the image corresponding to the image signals.

3. The image processing apparatus of claim 2,
wherein the output section outputs a reduced size image of the image corresponding to the image signals when the output section outputs the image relating to date and time information.

4. The image processing apparatus of claim 3,
wherein the output section outputs the reduce size image of the image in accordance with a result of judgment whether the image corresponding to the image signals and the image relating to date and time information are overlap with each other.

5. The image processing apparatus of claim 4,
wherein the output section controls a degree of the size reduction in accordance with a result of comparison a size of an available output area for the image relating to date and time information and a size of the image relating to date and time information.

6. The image processing apparatus of claim 2,
wherein the output section outputs the image corresponding to the image signals in accordance with size reduction information.

7. The image processing apparatus of claim 6,
wherein the size reduction information is obtained from outside of the apparatus.

8. The image processing apparatus of claim 2,
wherein the output section controls an output position of the image corresponding to the image signals in accordance with a result of judgment whether the image corresponding to the image signals and the image relating to date and time information are overlap with each other.

9. The image processing apparatus of claim 8,
wherein the output section controls the output position of the image in accordance with a result of comparison a size of an available output area for the image relating to date and time information and a size of the image relating to date and time information.

10. The image processing apparatus of claim 2,
wherein the output section outputs the image corresponding to the image signals in accordance with output position information.

11. The image processing apparatus of claim 10,
wherein the output position information is obtained from outside of the apparatus.

12. The image processing apparatus of claim 1,
wherein the output section outputs the image with or without the additional image in accordance with a result of judgment whether the date and time information meets the date and time for output.

13. The image processing apparatus of claim 12,
wherein the output section outputs the image relating to date and time information so as not to interfere with a composite image including the image corresponding to the image signals and the additional image.

14. The image processing apparatus of claim 13,
wherein the output section outputs a reduced size image of the composite image corresponding to the image signals when the output section outputs the image relating to date and time information.

15. The image processing apparatus of claim 14,
wherein the output section outputs the reduced size image of the composite image in accordance with a result of judgment whether the composite image and the image relating to date and time information are overlap with each other.

16. The image processing apparatus of claim 15,
wherein the output section controls a degree of the size reduction in accordance with a result of comparison a size of an available output area for the image relating to date and time information and a size of the image relating to date and time information.

17. The image processing apparatus of claim 13,
wherein the output section outputs the composite image in accordance with size reduction information.

18. The image processing apparatus of claim 17,
wherein the size reduction information is obtained from outside of the apparatus.

19. The image processing apparatus of claim 13,
wherein the output section controls an output position of the composite image in accordance with a result of judgment whether the composite image and the image relating to date and time information are overlap with each other.

20. The image processing apparatus of claim 19,
wherein the output section controls the output position of the composite image in accordance with a result of comparison a size of an available output area for the image relating to date and time information and a size of the image relating to date and time information.

21. The image processing apparatus of claim 13,
wherein the output section outputs the composite image in accordance with output position information.

22. The image processing apparatus of claim 21,
wherein the output position information is obtained from outside of the apparatus.

23. The image processing apparatus of claim 1, further comprising:
an additional image setting section which sets the additional image with the image corresponding to the image signals.

24. The image processing apparatus of claim 1,
wherein the additional image is set with the image corresponding to the image signals by an external additional image setting section.

25. The image processing apparatus of claim 1, further comprising:
a day and time information setting section which sets the day and time information with the image corresponding to the image signals.

26. The image processing apparatus of claim 1,
wherein the day and time information is set with the image corresponding to the image signals by an external day and time information setting section.

27. The image processing apparatus of claim 25,
wherein the day and time information setting section sets the day and time information with the additional image.

28. The image processing apparatus of claim 25,
wherein the day and time information setting section sets the day and time information with an area where the additional image is added.

29. The image processing apparatus of claim 25,
wherein the day and time information is obtained from an original document having the image.

30. The image processing apparatus of claim 29,
wherein the day and time information is obtained by reading the original document.

31. An image processing apparatus, comprising:
an image signals obtaining section which obtains image signals corresponding to an image;
a judgment section which judges whether date and time information meets date and time for output when the image is outputted based on the image signals, wherein the date and time information is used for judging whether the image is outputted with or without an additional image; and
an output section which outputs the image with an image relating to date and time information based on the date and time information when the judgment section judges the date and time information meets the date and time for output, and outputs the image without the image relating to date and time information when the judgment section judges the date and time information does not meet the date and time for output.

32. The image processing apparatus of claim 31,
wherein the output section outputs the image relating to date and time information so as not to interfere with the image corresponding to the image signals.

33. The image processing apparatus of claim 32,
wherein the output section outputs a reduced size image of the image corresponding to the image signals when the output section outputs the image relating to date and time information.

34. The image processing apparatus of claim 33,
wherein the output section outputs the reduce size image of the image in accordance with a result of judgment whether the image corresponding to the image signals and the image relating to date and time information are overlap with each other.

35. The image processing apparatus of claim 34,
wherein the output section controls a degree of the size reduction in accordance with a result of comparison a size of an available output area for the image relating to date and time information and a size of the image relating to date and time information.

36. The image processing apparatus of claim 32,
wherein the output section outputs the image corresponding to the image signals in accordance with size reduction information.

37. The image processing apparatus of claim 36,
wherein the size reduction information is obtained from outside of the apparatus.

38. The image processing apparatus of claim 32,
wherein the output section controls an output position of the image corresponding to the image signals in accordance with a result of judgment whether the image corresponding to the image signals and the image relating to date and time information are overlap with each other.

39. The image processing apparatus of claim 38,
wherein the output section controls the output position of the image in accordance with a result of comparison a size of an available output area for the image relating to date and time information and a size of the image relating to date and time information.

40. The image processing apparatus of claim 32,
wherein the output section outputs the image corresponding to the image signals in accordance with output position information.

41. The image processing apparatus of claim 40,
wherein the output position information is obtained from outside of the apparatus.

42. The image processing apparatus of claim 31,
wherein the output section outputs the image with or without the additional image in accordance with a result of judgment whether the date and time information meets the date and time for output.

43. The image processing apparatus of claim 42,
wherein the output section outputs the image relating to date and time information so as not to interfere with a composite image including the image corresponding to the image signals and the additional image.

44. The image processing apparatus of claim 43, wherein the output section outputs a reduced size image of the composite image corresponding to the image signals when the output section outputs the image relating to date and time information.

45. The image processing apparatus of claim 44,
wherein the output section outputs the reduced size image of the composite image in accordance with a result of judgment whether the composite image and the image relating to date and time information are overlap with each other.

46. The image processing apparatus of claim 45,
wherein the output section controls a degree of the size reduction in accordance with a result of comparison a size of an available output area for the image relating to date and time information and a size of the image relating to date and time information.

47. The image processing apparatus of claim 43,
wherein the output section outputs the composite image in accordance with size reduction information.

48. The image processing apparatus of claim 47,
wherein the size reduction information is obtained from outside of the apparatus.

49. The image processing apparatus of claim 43,
wherein the output section controls an output position of the composite image in accordance with a result of judgment whether the composite image and the image relating to date and time information are overlap with each other.

50. The image processing apparatus of claim 49,
wherein the output section controls the output position of the composite-image in accordance with a result of comparison a size of an available output area for the image relating to date and time information and a size of the image relating to date and time information.

51. The image processing apparatus of claim 43,
wherein the output section outputs the composite image in accordance with output position information.

52. The image processing apparatus of claim 51,
wherein the output position information is obtained from outside of the apparatus.

53. The image processing apparatus of claim 31, further comprising
an additional image setting section which sets the additional image with the image corresponding to the image signals.

54. The image processing apparatus of claim 31,
wherein the additional image is set with the image corresponding to the image signals by an external additional image setting section.

55. The image processing apparatus of claim 31, further comprising:
a day and time information setting section which sets the day and time information with the image corresponding to the image signals.

56. The image processing apparatus of claim 31,
wherein the day and time information is set with the image corresponding to the image signals by an external day and time information setting section.

57. The image processing apparatus of claim 55,
wherein the day and time information setting section sets the day and time information with the additional image.

58. The image processing apparatus of claim 55,
wherein the day and time information setting section sets the day and time information with an area where the additional image is added.

59. The image processing apparatus of claim 55,
wherein the day and time information is obtained from an original document having the image.

60. The image processing apparatus of claim 59,
wherein the day and time information is obtained by reading the original document.
